(19) United States
(12) Patent Application Publication
(10) Pub. No.: US 2012/0101645 A1
(43) Pub. Date: Apr. 26, 2012

(54) POWER CONTROL METHOD USING ORTHOGONAL-PERTURBATION, POWER GENERATION SYSTEM, AND POWER CONVERTER

(75) Inventors: Yong Il Jun, Daejeon (KR); Soo Young Oh, Daejun (KR)

(73) Assignee: ELECTRONICS AND TELECOMMUNICATIONS RESEARCH INSTITUTE, Daejeon (KR)

(21) Appl. No.: 13/379,031

(22) PCT Filed: Jun. 18, 2010
(86) PCT No.: PCT/KR2010/003935

§ 371 Date: Dec. 18, 2011

(30) Foreign Application Priority Data
Jun. 18, 2009 (KR) 10-2009-0054386

(51) Int. Cl. G06F 1/26; G05F 1/70

(52) U.S. Cl. 700/287; 323/209

(57) ABSTRACT

A power generation system is provided. The power generation system includes a plurality of power generators, an output combiner, and a power controller. The power generators are configured to add a perturbation signal to each output. The output combiner is configured to combine the output powers of the power generators.

The power controller is configured to cross-correlate the sum power of the perturbation signals of the power generators and the perturbation signals of the power generators and control the output powers of the power generators according to the cross-correlation result.

### CROSS-REFERENCE TO RELATED APPLICATIONS

This U.S. non-provisional patent application claims priority under 35 U.S.C. §119 of Korean Patent Application No. 10-2009-0054386, filed on Jun. 18, 2009, the entire contents of which are hereby incorporated by reference.

### BACKGROUND OF THE INVENTION

The present invention disclosed herein relates to a power control system, and more particularly, to a power control method outputting the maximum power by using an orthogonal-perturbation, a power generation system, and a power converter.

A solar cell or a photocell is a device that can convert solar energy into electrical energy. Electrons and holes are generated when light with an energy larger than a band gap is irradiated to a semiconductor P-N junction region. By an electric field formed to maintain the thermal equilibrium of junction region carriers, electrons move to an N-type semiconductor and holes move to a P-type semiconductor, thus generating an electromotive force. Thus, an electrode attached to the N-type semiconductor becomes a negative electrode, and an electrode attached to the P-type semiconductor becomes a positive electrode. Silicon, gallium arsenide, cadmium telluride, cadmium sulfide, indium, copper indium gallium selenide, and organic semiconductor material are used as the semiconductor material of a solar cell. In particular, silicon is widely used as the semiconductor material of a solar cell.

Solar cells are classified into a cell, a module, a string, and an array according to size. The cell is the attachment of electrodes to a single or multiple P-N junction surface as a negative electrode and a positive electrode. The cell exhibits output current characteristics proportional to the quantity of incident light and output voltage characteristics proportional to a semiconductor band gap. The module is the package of cells connected in series. The string is the serial connection of modules, and the array is the serial/parallel connection of strings. A solar cell system includes a solar cell array, a charge device storing output power, a regulator controlling the charge device, a maximum power tracking control device, and inverters for linkage with a backbone power system. Herein, the regulator, the maximum power tracking control device, and the inverters are commonly called a power conditioning system (PCS).

A solar cell exhibits the output characteristics of a circuit in which a constant current source is connected in parallel to a diode. Thus, the output current characteristics of a module are determined by a cell with the smallest output current among the constituent cells. The output current characteristics of the serially connected cells must be equal in order to derive the maximum power from solar battery cells. In a solar power generation system where the total number of modules is T, each string includes L modules, each array includes M strings connected in parallel, and N arrays are connected in series, T=LMN. A power generation loss rate according to the non-uniform module output characteristics of the above solar power generation system is expressed as Equation (1) (Reference Document 1: N. D. Kaushika et al., “An investigation of mismatch losses in solar photovoltaic cell networks,” ScienceDirect, www.sciencedirect.com, Energy-32, 2007).

$$E ( Δ P ) = \frac{( C + 2 )}{2} [ {σ}_{n}^{2} ( 1 - \frac{1}{T} ) - ( {σ}_{n}^{2} - {σ}_{m}^{2} ) ( M - 1 ) \frac{N}{T} ] \qquad ( 1 )$$

In Equation (1), C is a specific constant related to a fill factor of a solar cell, which has a value of 8˜11 in the case of a commercial silicon (Si) solar cell. σₙ is a value obtained by normalizing a standard deviation of the maximum power point current of a solar cell module by an average maximum power point current. σₘ is a value obtained by normalizing a standard deviation of the maximum power point voltage of the solar cell module by an average maximum power point voltage.

If the number T of modules is great, i.e., if the system capacity is very large, the maximum output point current normal variance must be maintained below 0.017 in order to maintain an output loss rate of below 10%. That is, the deviation of the maximum output point current values must be smaller than about 6%. Also, the deviation of the maximum output point current values is about 15%, the output loss rate reaches about 50%.

The output current characteristics of cell are determined by the operation environments and the physical characteristics of the cells. The output current characteristics according to the physical characteristics of the cells can be equalized by fabricating a module with selected cells. Examples of the operation environments of a solar cell include the quantity of incident light, the shadows of obstacles such as clouds or buildings, the surface contamination of the solar cell by dust, and the change of a light transmissivity by the degradation of the constituent materials of the solar cell. However, there is a limitation in equalizing the different characteristics according to the operation environments. According to the related research results, an output change rate of a module after about 5 years from use reaches about 5˜25% (Reference Document 2: Ahn HyungKeun, “Upcoming Subjects and Present Conditions of Solar Cell Module Technology,” Konkuk University, 2005).

FIG. 1 is a table illustrating the performances of conventional solar cells (Reference Document 3: Martin A. Green et al., “Solar Cell Efficiency Tables (version 32),” Progress in Photovoltaics: Research and Applications, On-line Journal www.interscience.wiley.com, June 2008). In FIG. 1, a silicon crystalline solar cell has a conversion efficiency of 24.7%, but the same type of a submodule has a conversion efficiency of 22.7% smaller by about 2% than 24.7%. Also, in FIG. 1, a silicon thin-film solar cell has a conversion efficiency of 16.6% but the same type of submodule has a conversion efficiency of 10.4%. In the case of a dye-sensitized solar cell, a Sharp corporation's cell has a conversion efficiency of 10.4%. However, a module with 9 serially-connected cells has a conversion efficiency of 8.2%.

The conversion efficiency difference of such solar cells and modules further increases in a solar cell that makes it difficult to maintain a physical uniformity. It is estimated that the conversion efficiency difference of solar cells and modules is caused by the characteristic non-uniformity of solar cells due to large areas. What is therefore required is a technique for efficiently deriving the maximum power generated by solar cells or arrays according to the output current characteristic change of solar cells due to environmental factors (Reference Document 4: Edon L. Meyer et al., “Assessing the Reliability and Degradation of Photovoltaic Module Performance parameters,” IEEE TRAN. On Reliability, Vol 53, NO. 1, March 2004).

The present invention is intended to prevent the degradation of a conversion efficiency due to the non-uniformity of physical characteristics caused by the large area of a high-capacity solar cell. If the cells of a solar cell module have different output characteristics, the cells with a short current smaller than a module output current act as resistors that consume electrical energy generated by other cells. That is, the cell which has short circuit current smaller than a module output current is reverse-biased to consume the power generated by other cells. A reversed-biased cell is called a hot-spot cell. A hot-spot cell may be heated by the electromotive force of other cells, and may be overheated and destroyed in the event of module short (Reference Document 5: M. C. Alona-Garcia et al., “Experimental study of mismatch and shading effects in the IV characteristic of a photovoltaic module,” www.sciencedirect.com). A hot-spot phenomenon can be prevented by attaching a bypass diode in the opposite polarity with respect to the solar cell electromotive force induced across cells. The bypass diode prevents the flow of an excessive reverse current in a reverse-biased cell, thus preventing a cell damage.

However, if the characteristics of constituent cells are not equal, a solar cell module mounted with a bypass diode has a multi-peak output power curve (Reference Document 6: S. Jain et al., “Comparison of the performance of maximum power point tracking schemes applied to single-stage grid-connected photovoltaic systems,” IET Electr.Power Appl., Vol.1, NO. 5, September 2007). It is difficult to apply a maximum power point tracking (MPPT) control to a solar cell module having a multi-peak output power curve. Also, a solar cell module having a multi-peak output power curve has a limitation in that it is impossible to extract the maximum power suppliable by solar cells of the solar cell module.

According to the research result, the maximum power creatable by silicon solar cells with short currents of 1.7 A, 0.34 A and 1.0 A is 1.82 Watt. However, an output power curve of a solar cell module, in which a bypass diode is attached to each of the above cells and they are connected in series, has two maximum power peak points of 0.588 Watt and 0.49 Watt. That is, the maximum power derivable from a solar cell module, which has three solar cells that are connected in series and generate the maximum 1.82 Watt power, is merely 0.588 Watt. This research result proves that the conversion efficiency decreases greatly (about ⅓ time in the above example) in the modularization of solar cells.

A typical solar cell MPPT technique uses a function property that a solar cell voltage (or current) versus power function is convex. Examples thereof are Hill-climbing or Perturb and Observation techniques using the convexity of an output curve, Incremental Conductance techniques using the inversion of the amplitude of AC impedance and DC impedance with respect to the maximum output point of an output curve, Ripple Cross-Correlation techniques using the inversion of the phase of current perturbation and voltage perturbation at the maximum power point, Fractional Voc and Fractional Isc techniques using the fact that a current and voltage value of the maximum output point is a constant ratio of an open voltage and a short current, Fuzzy Logic Control and Neural Network techniques processing a logic circuit of a Perturb and Observation technique by a fuzzy logic or neural network, Current Sweep techniques observing a solar cell terminal voltage by applying a current, the current differentiation value of which is proportional to the current amount, to a solar cell, DC Link Voltage Drop Control techniques minimizing a voltage drop of an inverter DC bus when it operates simultaneously with an inverter, Load Current (or Voltage) Maximization techniques maximizing an output current in the event of an operation under a constant voltage load such as a secondary cell and maximizing an output voltage in the event of a constant current load, and techniques measuring the current or voltage differentiation values of an output function and minimizing their absolute values (Reference Document 7: Trishan Esram et al., “Comparison of Photovoltaic Array Maximum Power Point Tracking Techniques,” IEEE Transactions on Energy Conversion, 2007). FIG. 2 is a technology comparison table cited from Reference Document 7.

Among the above techniques, the Ripple Cross-Correlation (RCC) techniques have the best performance in terms of the total output energy. The RCC techniques use a phenomenon that the phase of a perturbation current and voltage present naturally in a switching mode power conversion circuit is inverted at the maximum power point in comparison with the perturbation power (Reference Document 8: Comparison of the performance of maximum power point tracing schemes applied to single-stage grid-connected photovoltaic systems,” IEEE, Electric Power Applications, IET, Vol-1, Issue-5, page 753-762, Sept. 2007).

Time-integrating a function obtained by voltage-differentiating a power function of a solar cell results in the second formula of Equation (2).

$$\begin{matrix}d = {k}_{1} \int \frac{d p}{d v} d t \\ \approx {k}_{2} \int \frac{δ p}{δ v} d t \\ = {k}_{3} \int \frac{δ p}{δ v} {( δ v )}^{2} d t \\ = {k}_{3} \int δ p δ v d t \\ = {k}_{4} \int δ p δ i d t\end{matrix} \qquad ( 2 )$$

The differentiation value of the solar cell output power has a positive value at a voltage lower than the maximum power point, has a value of 0 at the maximum power point, and has a negative value at a voltage higher than the maximum power point. Thus, a value d obtained by time-integrating the power differentiation value becomes a control variable of a power converter controlling the solar cell output.

Also, the first formula of Equation (2) is approximated to the second formula. The sign relationship of the integration function is maintained even when the second formula is multiplied by the square of a perturbation voltage δv. That is, an integrand of the third formula has a positive value at a voltage lower than the maximum power point, has a value of 0 at the maximum power point, and has a negative value at a voltage higher than the maximum power point. The third formula is summarized as the fourth formula and the fifth formula. That is, a voltage or current control variable d of the power converter may be obtained by integrating the product of a perturbation power δp and a perturbation voltage δv or a perturbation current δi. The perturbation power, the perturbation voltage, and perturbation current may be measured at the point connecting the solar cell and the power conversion circuit.

An RCC MPPT control technology controls a power converter by using a perturbation signal generated naturally by the power converter. An RCC technique can perform a rapid control approaching a switching speed. However, the RCC technique has a limitation in that a plurality of perturbation signals interfere with each other when a plurality of power converters are used to control the output of solar cells. In other words, when a plurality of solar cells are processed by a plurality of power converters to perform a maximum power tracking control, the RCC technique cannot be applied. Also, because a switching signal and a control perturbation signal cannot be separated, when the RCC technique is applied to a power converter using a rapid switching signal, the phase shift of perturbation signals caused by the solar cell parasitic capacitance must be corrected (Reference Document 9: Jonathan W. Kimball and Philip T Krein, “Discrete-Time Ripple Correction Control for Maximum Power Point Tracking,” IEEE, Tran. on Power Electronics, Vol-23, No-5, page 2353-2362, Sept. 2008) (Reference Patent 1: P. Midya, P. T. Krein, and R. J. Turnbull, “Self-excited power minimizer/maximizer for switching power converters and switching motor driver applications,” U.S. Pat. No. 5,801,519, Sep. 1, 1998).

### SUMMARY OF THE INVENTION

Embodiments of the present invention provide a control method for extracting the maximum output or the necessary output by controlling a plurality of power generation devices with different characteristics simultaneously and independently.

Embodiments of the present invention also provide circuits for converting an energy source into a constant power source. The use of the conversion circuits makes it possible to prevent a power reduction phenomenon and a hot-spot phenomenon that may occur when solar cell modules with different characteristics are connected in series or in parallel.

Embodiments of the present invention also provide a technology for drawing the optimal power by combining a plurality of power generation devices.

In some embodiments of the present invention, power generation systems include: a plurality of power generators configured to add a perturbation signal to each output; an output combiner configured to combine the output powers of the power generators; and a power controller configured to cross-correlate the sum power of the perturbation signals of the power generators and the perturbation signals of the power generators and control the output powers of the power generators according to the cross-correlation result.

In other embodiments of the present invention, power converters include: a capacitor configured to charge or discharge the output power received from a power generation device; and a switching control unit configured to the charge or discharge of the capacitor according to an orthogonal perturbation signal and a control variable value generated by cross-correlating the orthogonal perturbation signal.

In further embodiments of the present invention, power control methods include: adding a first perturbation signal to the output of a first power generator and adding a second perturbation signal, which is orthogonal to the first perturbation signal, to the output of a second power generator; extracting a perturbation power corresponding to the sum power of the first perturbation signal and the second perturbation signal from the sum power of the first power generator and the second power generator; cross-correlating the extracted perturbation power with the first perturbation signal, and the second perturbation signal; and controlling the output powers of the first power generator and the second power generator according to the cross-correlation results.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a table illustrating the performance of a conventional solar cell;

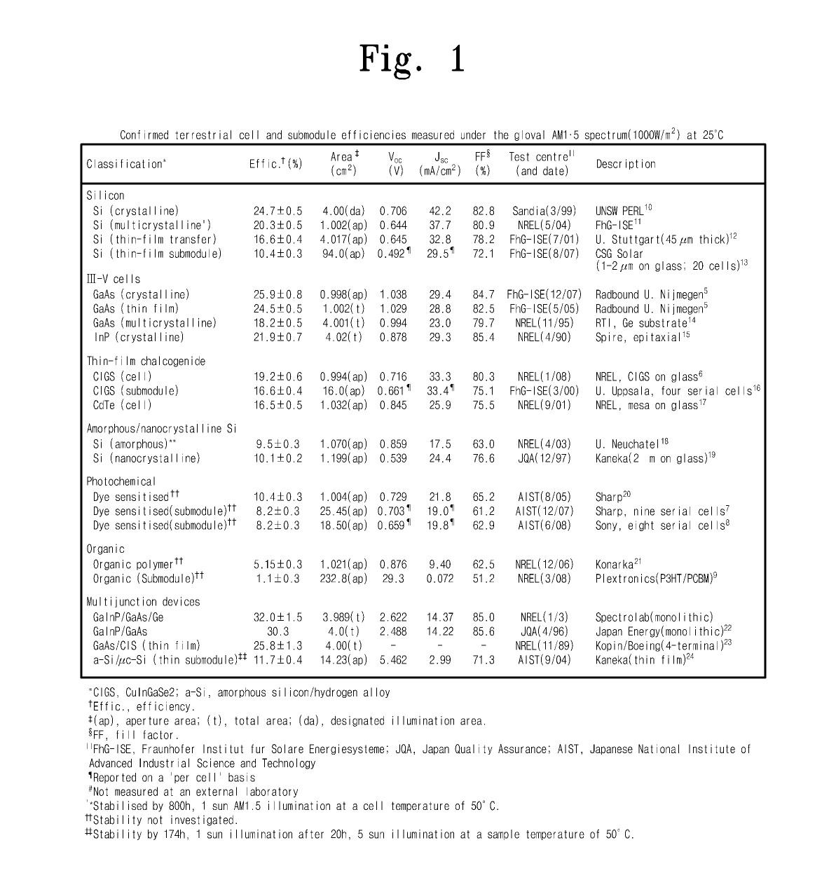

FIG. 2 is a table illustrating the comparison of conventional maximum power point tracking (MPPT) techniques;

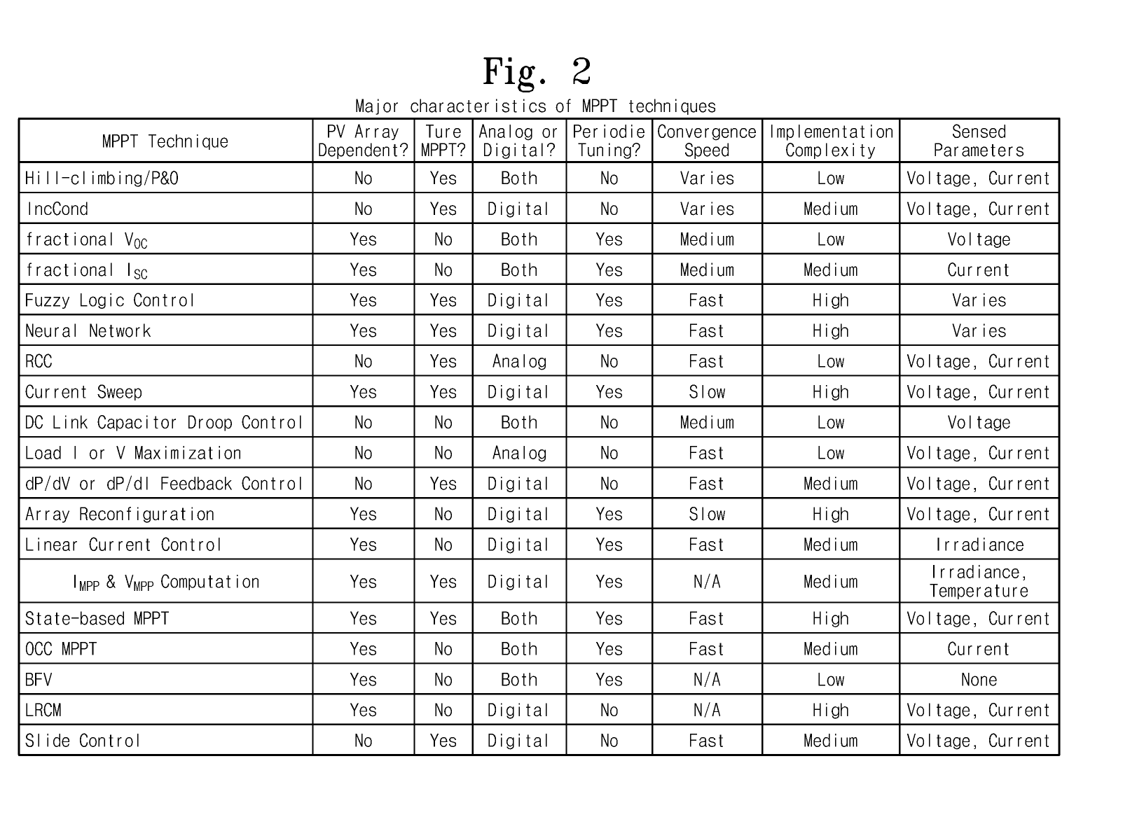

FIG. 3 is a diagram illustrating a system using a method of inducing the optimal output from a plurality of power generators using an orthogonal-perturbation according to an embodiment of the present invention;

FIG. 4 is a diagram illustrating a system using an optimal output control method in which a plurality of power generators using an orthogonal-perturbation are connected in series according to an embodiment of the present invention;

FIG. 5 is a circuit diagram illustrating an embodiment of configuring a power converter of FIG. 4 with a buck converter using a voltage or current sensing method;

FIG. 6 is a circuit diagram illustrating an embodiment of configuring a power converter of FIG. 4 with a buck converter of a duty-ratio control method;

FIG. 7 is a circuit diagram illustrating an embodiment of configuring a power converter of FIG. 4 with a cuk converter using a voltage or current sensing method;

FIG. 8 is a circuit diagram illustrating an embodiment of configuring a power converter of FIG. 4 with a cuk converter of a duty-ratio control method;

FIG. 9 is a waveform diagram illustrating the operation simulation results of a power converter according to an embodiment of the present invention; and

FIG. 10 is a waveform diagram illustrating a waveform adjacent to the maximum power output point in an embodiment of the present invention.

### DETAILED DESCRIPTION OF PREFERRED EMBODIMENTS

Preferred embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

Hereinafter, a description will be given of a method for controlling a plurality of power generation devices by a plurality of power converters and controlling the power generation devices to output the maximum power simultaneously. According to a maximum power point tracking (MPPT) control method of the present invention, a perturbation voltage or a perturbation current is generated in each of a plurality of power generators. The perturbation voltage or the perturbation current generated in each of the power generators are orthogonal to each other. The perturbation voltage or the perturbation current is artificially generated independently of a switching signal of the power converters.

In other words, a perturbation power δp^{s}ₒₜₕ is generated by a perturbation voltage source δv^{s}ₒₜₕ or a perturbation current source δi^{s}ₒₜₕ independently of a switching signal of a power converter corresponding to the sth energy source among a plurality of energy sources. Herein, ‘s’ denotes the s^{th} perturbation source, and ‘oth’ denotes an orthogonal signal that the cross-correlation of different perturbation signals approaches 0. Equation (2), determined by the convex characteristics of a voltage-power curve and the finiteness of energy, is satisfied even when a perturbation power is generated by a separate perturbation voltage source or current source. Thus, an s^{th} power converter control variable d^{s} can be expressed as Equation (3) by the perturbation power δp^{s}ₒₜₕ generated by the perturbation voltage source δv^{s}ₒₜₕ or the perturbation current source δi^{s}ₒₜₕ.

$$\begin{matrix}{d}^{s} = {k}_{1}^{s} \int \frac{d {p}^{s}}{d {v}^{s}} d t \\ \approx {k}_{2}^{s} \int \frac{δ {p}_{oth}^{s}}{δ {v}_{oth}^{s}} d t \\ = {k}_{3}^{s} \int δ {p}_{oth}^{s} δ {v}_{oth}^{s} d t \\ = {k}_{3}^{s} \int δ {p}_{oth}^{s} δ {i}_{oth}^{s} d t\end{matrix} \qquad ( 3 )$$

In a device controlling a plurality of power generation devices by a plurality of power controllers to combine the outputs, there is a point where the sum of perturbation powers generated by n energy sources in the device is present. If a perturbation power measured at the point is δpₛᵤₘ, it can be expressed as Equation (4).

$$δ {p}_{sum} ( t ) = {\sum }_{s = 1}^{n} {k}_{4}^{s} δ {p}_{oth}^{s} ( t - {T}_{d}^{s} ) \qquad ( 4 )$$

wherein k^{s}₄ denotes a proportional constant determined by the circuit characteristics, and T^{s}_{d} denotes the sum of a time delay from the s^{th} energy source to the perturbation power observation point and a time delay of a perturbation power measurement circuit.

As well known in the art, the s^{th} voltage and current perturbation sources δv^{s}ₒₜₕ and δi^{s}ₒₜₕ can be configured with a random orthogonal signal such as Gold code based on a PRBS (Pseudo Random Binary Sequence). Thus, the sth power converter control variable d^{s} can be expressed as Equation (5) by the orthogonalty of perturbation signals.

$$\begin{matrix}{d}^{s} ( t ) = {k}_{3}^{s} \int δ {p}_{sum} ( t ) δ {i}_{oth}^{s} ( t - {T}_{d}^{s} ) d t \\ = {k}_{3}^{s} \int δ {p}_{sum} ( t ) δ {v}_{oth}^{s} ( t - {T}_{d}^{s} ) d t \\ = {k}_{3}^{s} \int [ {\sum }_{i = 1}^{N} {k}_{4}^{i} δ {p}_{oth}^{i} ( t - {T}_{d}^{i} ) ] δ {i}_{oth}^{s} ( t - {T}_{d}^{s} ) d t \\ = {k}_{3}^{s} \int [ {\sum }_{i = 1}^{N} {k}_{4}^{i} δ {p}_{oth}^{i} ( t - {T}_{d}^{i} ) ] δ {v}_{oth}^{s} ( t - {T}_{d}^{s} ) d t \\ = {k}_{5}^{s} \int δ {p}_{oth}^{s} ( t - {T}_{d}^{s} ) δ {i}_{oth}^{s} ( t - {T}_{d}^{s} ) d t \\ = {k}_{6}^{s} \int δ {p}_{oth}^{s} ( t - {T}_{d}^{s} ) δ {v}_{oth}^{s} ( t - {T}_{d}^{s} ) d t\end{matrix} \qquad ( 5 )$$

In Equation (5), if the sum δpₛᵤₘ of perturbation powers generated in a plurality of power generation can be measured, the power converter control variable d^{s}(t) controlling the output power of s'th power generation device can be obtained by cross-correlating the power controller perturbation signals δv^{s}ₒₜₕ or δi^{s}ₒₜₕ with the total sum of the perturbation powers δpₛᵤₘ. The time delay T^{s}_{d} by the power converter and the perturbation power measurement circuit necessary in the cross-correlation operation may be obtained through separate measurement or by a synchronization circuit.

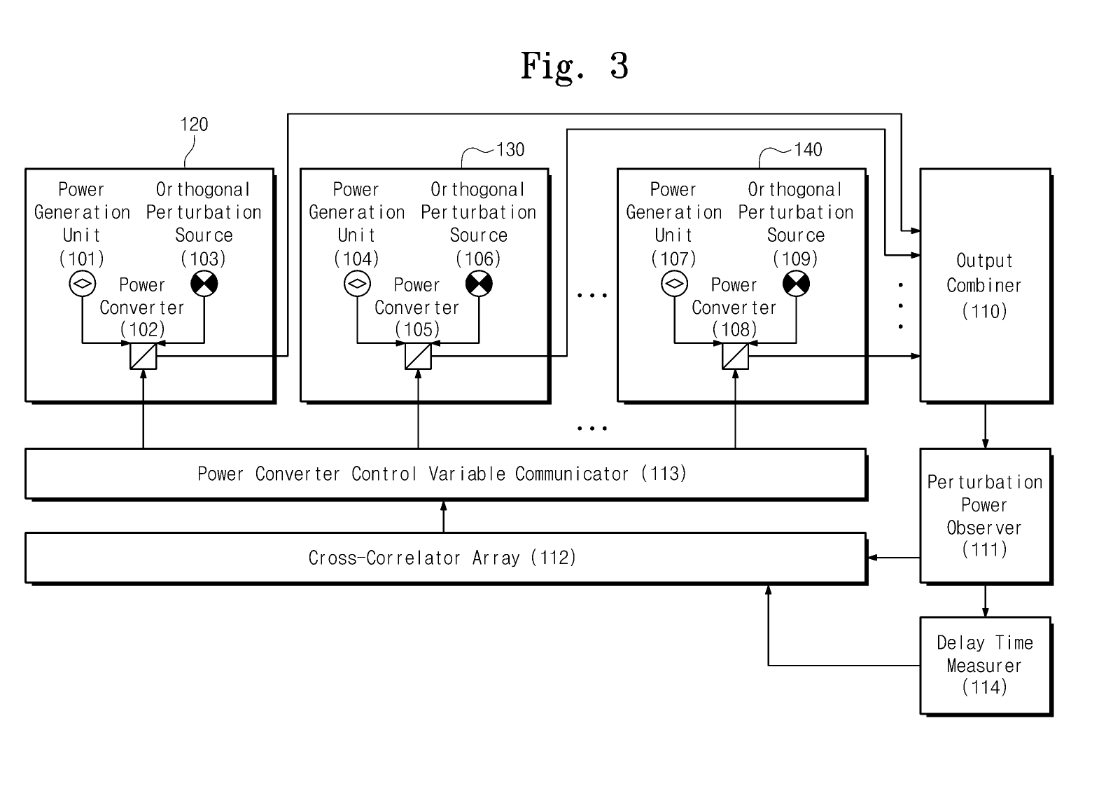

FIG. 3 is a block diagram illustrating a power generation system of a maximum power point tracking (MPPT) method according to the present invention. Referring to FIG. 3, the output power of a power generation device 101 is controlled by a power converter 102. The output power of a power generation device 101 controlled by the power converter 102 is transferred to an output combiner 110 as an optimal power. An orthogonal perturbation source 103 controls the power converter 102 so that an orthogonal power perturbed in the shape of a signal of the orthogonal perturbation source 103 is included in the optimal power transferred to the output combiner 110. This control relationship is similarly satisfied in a power generation device 104, an orthogonal perturbation source 106, and a power converter 105. Also, the control relationship is similarly satisfied in a power generation device 107, an orthogonal perturbation source 109, and a power converter 108. The orthogonal perturbation powers generated by the power generation devices 101, 104 and 107 under the control of the power converters 102, 105 and 108 are added by the output combiner 110. The added orthogonal perturbation powers are retained in the output combiner 110.

A perturbation power observer 111 measures the perturbation power retained in the output combiner 110. At this point, the perturbation power observer 111 removes unnecessary interference signals present in the output combiner 110. Also, the perturbation power measurer 111 corrects the waveform of the orthogonal perturbation power so that the orthogonal perturbation powers maintain the relationship of Equation (4). That is, the perturbation power observer 111 includes an equalizer function for the orthogonal perturbation powers. Also, the perturbation power observer 111 may include an optimal filter for blocking an interference signal and noise in order to measure the sum of the orthogonal perturbation powers at a high signal-to-noise ratio (SNR).

The orthogonal perturbation powers observed and added by the perturbation power observer 111 are provided to a cross-correlator array 112. The cross-correlator array 112 cross-correlates the sum of the orthogonal perturbation powers and a copy signal of each of the orthogonal perturbation sources 103, 106 and 109. A control variable d for each of the power converters 102, 105 and 108 is generated according to the cross-correlation of the copy signal and the sum of the orthogonal perturbation powers.

The control variables d for the power converters 102, 105 and 108 generated by the cross-correlator array 112 are inputted through a power converter control variable communicator 113 to into the power converters 102, 105 and 108. The power converters 102, 105 and 108 use the respective control variables d to control the output powers of the corresponding power generation devices 101, 104 and 107.

A delay time measurer 114 measures a delay time taken to transfer the generated orthogonal perturbation powers of the power generation device 101, 104 and 107 to the perturbation power observer 111. The delay time measurer 114 measures a time delay by the observed orthogonal perturbation power and transfers the measured time delay to the cross-correlator array 112. According to the time delay, the cross-correlator array 112 cross-correlates the copied orthogonal perturbation signals present therein. The delay time measurer 114 may be implemented using a memory device that stores the measured system delay time.

The orthogonal perturbation sources 103, 106 and 109 may be orthogonal to each other in terms of time, frequency and code. If implemented by time-based orthogonal signals, the orthogonal perturbation sources 103, 106 and 109 may be implemented by Pulse Position Modulation (PPM) signals. If implemented by frequency-based orthogonal signals, the orthogonal perturbation sources 103, 106 and 109 may be implemented by Orthogonal Frequency Division Multiplexing (OFDM) signals. If implemented by code-based orthogonal signals, the orthogonal perturbation sources 103, 106 and 109 may be implemented by Pseudo Random Binary Sequence (PRBS) signals. The above implementation schemes for the orthogonal perturbation sources 103, 106 and 109 are merely exemplary, and it will be apparent to those skilled in the art that all types of orthogonal signals may be used to implement the orthogonal perturbation sources 103, 106 and 109.

Also, a scheme for communication between the power converters 102, 105 and 108 corresponding to the power converter control variable communicator 113 may be implemented variously. For example, the power converter control variable communicator 113 may use a communication channel according to an independent communication scheme using an independent communication channel for each of the power converters 102, 105 and 108, a Time Division Multiplexing (TDM) scheme using one communication channel in a time division manner, a Frequency Division Multiplexing (FDM) scheme (e.g., an OFDM scheme) using one communication channel in a frequency division manner, or a Code Division Multiple Access (CDMA) scheme using one communication channel in a code division manner. Also, a combination of the above communication schemes may be used as a scheme for communication between the power converter control variable communicator 113 and the power converters 102, 105 and 108.

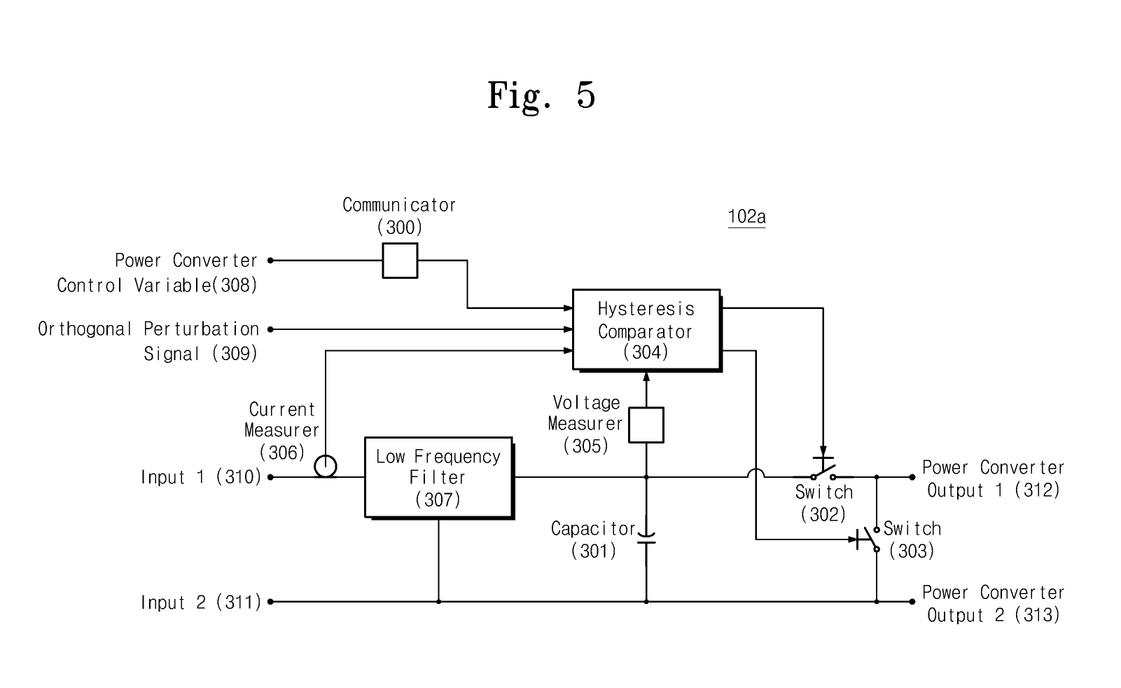

The power converter control variable communicator 113 may perform system operations other than the MPPT operation by communicating information necessary for system initiation and maintenance with a communicator 300 (see FIG. 5 described later) present in the corresponding power converters 102, 105 and 108.

The power generation device 101, the orthogonal permutation source 103, and the power converter 102 constitute a power generator 120. The power generation device 104, the orthogonal permutation source 106, and the power converter 105 constitute a power generator 130. The power generation device 107, the orthogonal permutation source 109, and the power converter 108 constitute a power generator 140. Herein, each of the power generators 120, 130 and 140 may be configured in one of units of solar cell, module, string or array. Each of the power generators 120, 130 and 140 may also be configured in the form of a wind power generator, other various generators, or a combination of a plurality of power generation schemes.

The output combiner 110, the perturbation power observer 111, the cross-correlator array 112, the power converter control variable communicator 113, and the delay time measurer 114 constitute a power controller for controlling the output power of each of the power generators 120, 130 and 140.

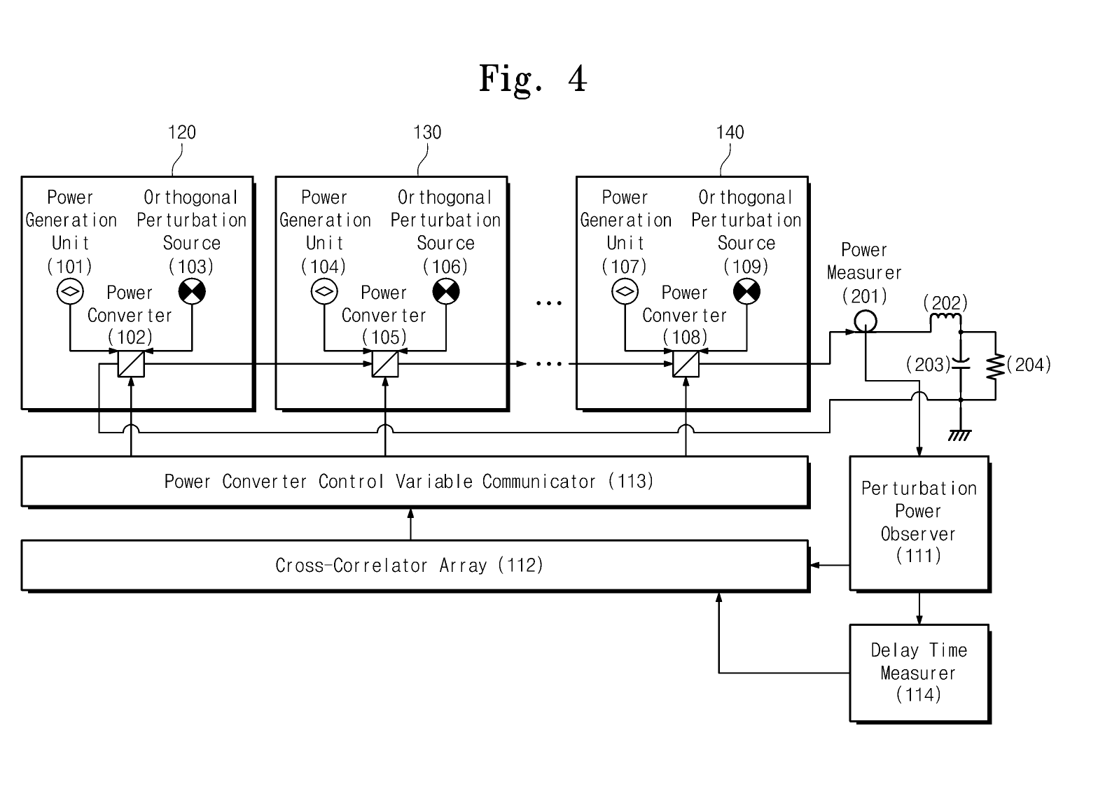

FIG. 4 is a block diagram illustrating the structure of an MPPT controller including power converters 102, 105 and 108 connected in series according to another embodiment of the present invention. In FIGS. 3 and 4, like reference numerals denote like elements. Referring to FIG. 4, the functions and configurations of power generations device 101, 104 and 107, orthogonal perturbation sources 103, 106 and 109, and power converters 102, 105 and 108 are the same as those of FIG. 3.

In FIG. 4, an inductor 202, a capacitor 203, and a load resistor 204 constitute a low frequency filter. That is, the inductor 202, the capacitor 203, and the load resistor 204 serve as the output combiner 110 illustrated in FIG. 3. A power measurer 201 measures the power inputted from the serially-connected power converters 102, 105 and 108 into the inductor 202. A perturbation power observer 111 extracts a perturbation power from the power measured by the power measurer 201. A cross-correlator array 112 uses the observed perturbation power to generate control variables d^{s} for controlling the power converters 102, 105 and 108. The generated control variables d^{s} are transferred through a power converter control variable communicator 113 to the power converters 102, 105 and 108. According to the control variables d^{s}, the power converters 102, 105 and 108 control the power generation devices 101, 104 and 107 so that the generated powers are maximally transferred to the load resistor 204.

Herein, the power generation device 101, the orthogonal permutation source 103, and the power converter 102 constitute a power generator 120. The power generation device 104, the orthogonal permutation source 106, and the power converter 105 constitute a power generator 130. The power generation device 107, the orthogonal permutation source 109, and the power converter 108 constitute a power generator 140. Herein, each of the power generators 120, 130 and 140 may be configured in one of units of solar cell, module, string or array. Each of the power generators 120, 130 and 140 may also be configured in the form of a wind power generator, other various generators, or a combination of a plurality of power generation schemes.

The power measurer 201, the perturbation power observer 111, the cross-correlator array 112, the power converter control variable communicator 113, and the delay time measurer 114 constitute a power controller for controlling the output power of each of the power generators 120, 130 and 140.

FIG. 5 is a diagram illustrating an embodiment of the configurations and functions of the power converters 102, 105 and 108 of FIG. 4. The power converters 102, 105 and 108 have the same structure. Thus, for the convenience of description, embodiments 102a, 102b, 102c and 102d of the power converter 102 will be described with reference to FIGS. 5 to 8.

Referring to a power converter 102a of FIG. 5, a first input 310 and a second input 311 are terminals through which the power generation devices 101, 104 and 107 of FIG. 4 are connected to the corresponding power converters 102, 105 and 108. A first power converter output 312 and a second power converter output 313 correspond to output terminals that connect the power converters 102, 105 and 108 in series. A power converter control variable 308 corresponds to a terminal for receiving a control variable signal d^{s} inputted from the power converter control variable communicator 113. An orthogonal perturbation signal 309 corresponds to a terminal for receiving orthogonal perturbation signals inputted from the orthogonal perturbation sources 103, 106 and 109.

A communicator 300 receives control variable signals from the power converter control variable communicator 113, and transfers the received control variable signals to a hysteresis comparator 304. The communicator 300 obtains information necessary for the initiation and maintenance of one of the power converters 102, 105 and 108 by communicating with the power converter control variable communicator 113. The communicator 300 uses the obtained information to perform a system control function and a system Operation And Maintenance (OAM) function.

The hysteresis comparator 304 uses a measurement value received from one of a current measurer 306 and a voltage measurer 305. That is, the hysteresis comparator 304 operates using an exclusively-selected measurement value received from one of the current measurer 306 and the voltage measurer 305. If the hysteresis comparator 304 uses a measurement value received from the current measurer 306, it does not necessarily need to receive a measurement value from the voltage measurer 305, and the vise versa.

A description will be given of an example where the hysteresis comparator 304 uses a measurement value of the current measurer 306. The operation parameters of the hysteresis comparator 304 are determined by the power converter control variable 308 and the orthogonal perturbation signal 309. That is, a reference current value is determined by the power converter control variable 308 and the orthogonal perturbation signal 309 transferred to the hysteresis comparator 304. The hysteresis comparator 304 compares two threshold current values having the reference current value as a mean value (i.e., a minimum threshold current value and a maximum threshold current value) and a current measurement value received from the current measurer 306. According to the comparison result, the hysteresis comparator 304 turns on or off switches 302 and 303.

That is, if the current measurement value received from the current measurer 306 is greater than the maximum threshold current value, the hysteresis comparator 304 turns off the switch 302 and turns on the switch 303. Then, a capacitor 301 charges the capacitive energy of the power generation device received through a low frequency filter 307. On the other hand, if the current measurement value received from the current measurer 306 is smaller than the minimum threshold current value, the hysteresis comparator 304 turns on the switch 302 and turns off the switch 303. Then, the capacitor 301 discharges the stored capacitive energy through the first power converter output 312 and the second power converter output 313. If the current measurement value received from the current measurer 306 is between the minimum threshold current value and the maximum threshold current value, the hysteresis comparator 304 maintains the states of the switches 302 and 303.

Thus, the amount of a current flowing from the power generation devices 101, 104 and 107 into the power converters 102, 105 and 108 is maintained between the minimum threshold current value and the maximum threshold current value by the hysteresis comparator 304. That is, by the power converters 102, 105 and 108, the power generation devices 101, 104 and 107 operate as a constant power source.

Also, by an inductance component (not illustrated) present in the low frequency filter 307, the power converter 102 of FIG. 5 constitutes an LCR (t) resonation circuit controlled by the switch 302. In this case, the power converter 102 has hysteresis characteristics at a specific circuit value. Accordingly, the hysteresis comparator 304 may have a single threshold current value.

A description will be given of an example where the hysteresis comparator 304 uses a measurement value of the voltage measurer 305. The operation parameters of the hysteresis comparator 304 are determined by the power converter control variable 308 and the orthogonal perturbation signal 309. That is, a reference voltage value is determined by the power converter control variable 308 and the orthogonal perturbation signal 309 transferred to the hysteresis comparator 304. The hysteresis comparator 304 compares two threshold voltage values having the reference voltage value as a mean value (i.e., a minimum threshold voltage value and a maximum threshold voltage value) and a voltage measurement value received from the voltage measurer 305. According to the comparison result, the hysteresis comparator 304 turns on or off the switches 302 and 303.

If the voltage measurement value received from the voltage measurer 305 is greater than the maximum threshold voltage value, the hysteresis comparator 304 turns on the switch 302 and turns off the switch 303. On the other hand, if the voltage measurement value received from the voltage measurer 305 is smaller than the minimum threshold voltage value, the hysteresis comparator 304 turns off the switch 302 and turns on the switch 303. If the voltage measurement value received from the voltage measurer 305 is between the minimum threshold voltage value and the maximum threshold voltage value, the hysteresis comparator 304 maintains the previous states of the switches 302 and 303.

Thus, the voltages of the output terminals of the power generation devices 101, 104 and 107 and the voltage of the capacitor 301 are maintained between the minimum threshold voltage value and the maximum threshold voltage value of the hysteresis comparator 304. That is, by the power converters 102, 105 and 108, the power generation devices 101, 104 and 107 operate as a constant power source.

Also, by an inductance component (not illustrated) present in the low frequency filter 307, the power converter 102 of FIG. 5 includes an LCR (t) resonation circuit function controlled by the switch 302. In this case, the power converter 102 performs a hysteresis operation at a specific circuit value. Accordingly, the hysteresis comparator 304 may have a single threshold voltage value. Also, the low frequency filter 307 prevents a switching noise of the switches 302 and 303 from being transferred to a power generation device (not illustrated). Thus, the low frequency filter 307 maintains the output of the power generation device to be adjacent to the maximum possible output point.

The current or voltage measurement points of the current measurer 306 and the voltage measurer 305 may be present in the low frequency filter 307. However, in this case, the measurement must be able to correct the phase shift by the circuits in the low frequency filter 307.

Consequently, the power converter 102a of FIG. 5 according to an embodiment of the present invention is controlled by a voltage or a current in a hysteresis manner, and may constitute a buck converter including the communicator (300) function capable of providing a control variable. A current sensor or a voltage sensor is necessary to constitute the power converter 102a of FIG. 5. Thus, it is expected that a high cost is taken to implement the power converter 102a of FIG. 5. On the other hand, the power generation device can always operate as a constant power source by measuring and controlling an output current or voltage value.

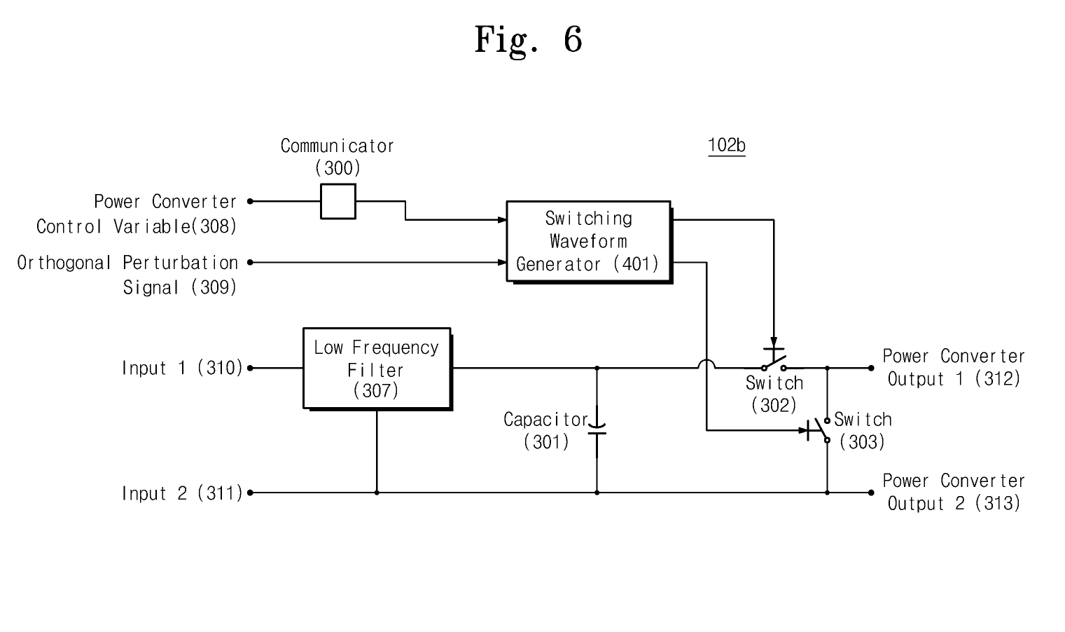

FIG. 6 is a block diagram illustrating another embodiment of the functions of the power converters 102, 105 and 108 of FIG. 4. Thus, a power converter 102b of FIG. 6 has the same input/output terminals as the power converter 102a of FIG. 5. Also, the power converter 101b of FIG. 6 and the power converter 102a of FIG. 5 are identical in terms of the functions of the low frequency filter 307, the capacitor 301, and the switches 302 and 303.

A communicator 300 receives control variable signals from the power converter control variable communicator 113, and transfers the received control variable signals to a switching waveform generator 401. The communicator 300 obtains information necessary for the initiation and maintenance of the power converter 102b by communicating with the power converter control variable communicator 113. The communicator 300 uses the obtained information to perform a system control function and a system Operation And Maintenance (OAM) function.

The switching waveform generator 401 includes a sawtooth wave generator (not illustrated) that generates a sawtooth wave with a predetermined frequency and amplitude. From the power converter control variable 308 and the orthogonal perturbation signal 309, the switching waveform generator 401 generates a reference value to be compared with the sawtooth wave. According to the result of the real-time comparison of the reference value and the sawtooth wave, the switching waveform generator 401 generates a switch control signal for controlling the switches 302 and 303.

For example, if the reference value is greater than the level of the sawtooth wave, the switching waveform generator 401 turns on the switch 302 and turns off the switch 303. If the reference value is smaller than the level of the sawtooth wave, the switching waveform generator 401 turns off the switch 302 and turns on the switch 303. That is, if the value of the power converter control variable 308 is great, the switching waveform generator 401 controls the switches 302 and 303 by generating a switch control signal providing a high duty ratio. For example, the power converter 102b of FIG. 6 is controlled by a duty ratio, and may be a buck converter including the communicator (300) function capable of communicating a control variable. Unlike the power converter 102a of FIG. 5, the power converter 102b of FIG. 6 does not need a voltage or current sensor. Thus, the power converter 102b of FIG. 6 can be implemented at a relatively low cost.

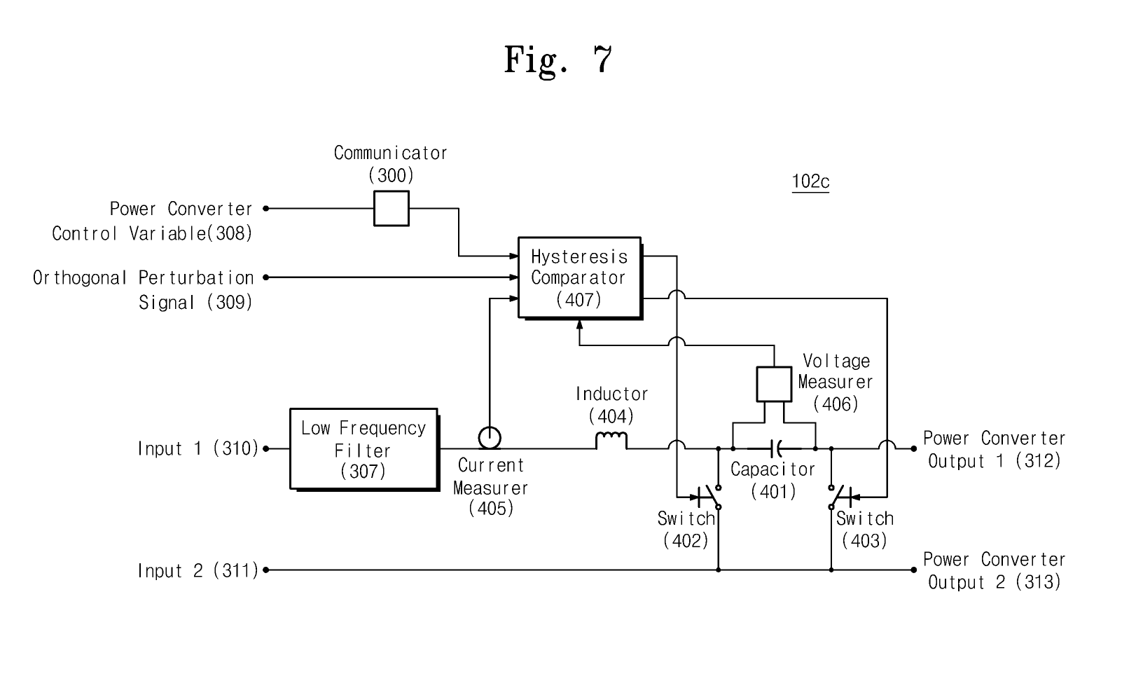

FIG. 7 is a block diagram illustrating still another embodiment of the power converters 102, 105 and 108 of FIG. 4. Thus, a power converter 102c of FIG. 7 has the same input/output terminals as the power converter 102a of FIG. 5.

A communicator 300 receives control variable signals from the power converter control variable communicator 113, and transfers the received control variable signals to a hysteresis comparator 407. The communicator 300 obtains information necessary for the initiation and maintenance of the power converter 102c by communicating with the power converter control variable communicator 113. The communicator 300 uses the obtained information to perform a system control function and a system Operation And Maintenance (OAM) function.

The hysteresis comparator 407 uses a measurement value received from one of a current measurer 405 and a voltage measurer 406. That is, the hysteresis comparator 407 operates using an exclusively-selected measurement value received from one of the current measurer 405 and the voltage measurer 406. If the hysteresis comparator 407 uses a measurement value received from the current measurer 405, it does not necessarily need to receive a measurement value from the voltage measurer 406, and the vise versa.

A description will be given of an example where the hysteresis comparator 407 uses a measurement value of the current measurer 405. The operation parameters of the hysteresis comparator 407 are determined by the power converter control variable 308 and the orthogonal perturbation signal 309. That is, a reference current value is determined by the power converter control variable 308 and the orthogonal perturbation signal 309 transferred to the hysteresis comparator 407. The hysteresis comparator 407 compares two threshold current values having the reference current value as a mean value (i.e., a minimum threshold current value and a maximum threshold current value) and a current value of an inductor 404 received from the current measurer 405. According to the comparison result, the hysteresis comparator 407 turns on or off switches 402 and 403.

That is, if the current measurement value received from the current measurer 405 is greater than the maximum threshold current value, the hysteresis comparator 407 turns off the switch 402 and turns on the switch 403. Then, the inductive energy stored in the inductor 404 is transferred to a capacitor 401. On the other hand, if the current measurement value received from the current measurer 405 is smaller than the minimum threshold current value, the hysteresis comparator 407 turns on the switch 402 and turns off the switch 403. Accordingly, the inductor 404 is recharged with inductive energy, and the capacitor 401 discharges energy through the power converter outputs 312 and 313 to the outside of the power converter.

If the current measurement value received from the current measurer 405 is between the minimum threshold current value and the maximum threshold current value, the hysteresis comparator 407 maintains the states of the switches 402 and 403. Thus, the amount of a current flowing from the power generation devices 101, 104 and 107 into the power converters 102, 105 and 108 is maintained between the minimum threshold current value and the maximum threshold current value by the hysteresis comparator 407. That is, by the power converter 102c, the power generation device operates as a constant power source.

By an inductance component present in the low frequency filter 307, the power converter 102c of FIG. 7 constitutes an LCR (t) time-varying resonation circuit controlled by the switch 402. In this case, the power converter 102c performs a hysteresis operation at a specific circuit value. Accordingly, the hysteresis comparator 407 may have a single threshold current value.

A description will be given of an example where the hysteresis comparator 407 uses a measurement value of the voltage measurer 406. The operation parameters of the hysteresis comparator 407 are determined by the power converter control variable 308 and the orthogonal perturbation signal 309. That is, a reference voltage value is determined by the power converter control variable 308 and the orthogonal perturbation signal 309 transferred to the hysteresis comparator 407. The hysteresis comparator 407 compares two threshold voltage values having the reference voltage value as a mean value (i.e., a minimum threshold voltage value and a maximum threshold voltage value) and a voltage value across the capacitor 401 received from the voltage measurer 406. According to the comparison result, the hysteresis comparator 407 turns on or off the switches 402 and 403.

That is, if the voltage measurement value received from the voltage measurer 406 is greater than the maximum threshold voltage value, the hysteresis comparator 407 turns on the switch 402 and turns off the switch 403. Accordingly, the inductor 404 is charged with inductive energy, and the capacitor 401 discharges energy through the power converter outputs 312 and 313 to the outside of the power converter. On the other hand, if the voltage measurement value received from the voltage measurer 406 is smaller than the minimum threshold voltage value, the hysteresis comparator 407 turns off the switch 402 and turns on the switch 403. Then, the inductive energy stored in the inductor 404 is transferred to the capacitor 401. If the voltage measurement value received from the voltage measurer 406 is between the minimum threshold voltage value and the maximum threshold voltage value, the hysteresis comparator 407 maintains the previous states of the switches 402 and 403.

Accordingly, the voltage of the output terminal of the power generation device 101 and the voltage of the capacitor 401 are maintained between the minimum threshold voltage value and the maximum threshold voltage value by the hysteresis comparator 407. That is, by the power converter 102c, the power generation device 101 operates as a constant power source.

By an inductance component present in the low frequency filter 307, the power converter 102c of FIG. 7 constitutes an LCR (t) time-varying resonation circuit controlled by the switch 402. In this case, the power converter 102c performs a hysteresis operation at a specific circuit value. Accordingly, the hysteresis comparator 407 may have a single threshold voltage value.

The low frequency filter 307 prevents a switching noise of the switches 402 and 403 from being transferred to an energy source. Thus, the low frequency filter 307 controls the power generation device 101 to operate at a point adjacent to the maximum possible output point.

The current or voltage measurement points of the current measurer 405 and the voltage measurer 406 may be present in the low frequency filter 307. However, in this case, the measurement must be able to correct the phase shift by the circuits in the low frequency filter 307.

Consequently, the power converter 102c of FIG. 7 according to an embodiment of the present invention is controlled by a voltage or a current in a hysteresis manner, and may constitute a cuk converter including the communicator (300) function capable of providing a control variable.

A current sensor or a voltage sensor is necessary to constitute the power converter 102c of FIG. 7. Thus, it is expected that a high cost is taken to implement the power converter 102c of FIG. 7. On the other hand, the power generation device 101 can always operate as a constant power source by measuring and controlling a current or voltage value outputted from the power generation device 101.

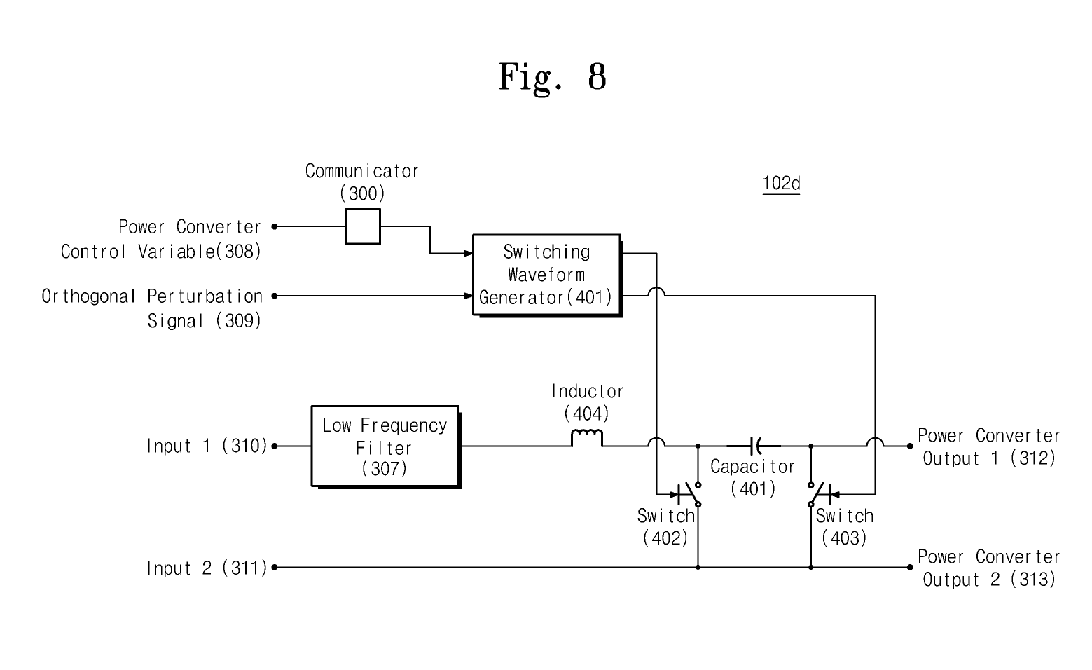

FIG. 8 is a block diagram illustrating still another embodiment of one of the power converters 102, 105 and 108 of FIG. 4. Thus, a power converter 102d of FIG. 8 has the same input/output terminals as the power converter 102a of FIG. 5.

A communicator 300 receives control variable signals from the power converter control variable communicator 113, and transfers the received control variable signals to a switching waveform generator 401. The communicator 300 obtains information necessary for the initiation and maintenance of the power converter 102b by communicating with the power converter control variable communicator 113. The communicator 300 uses the obtained information to perform a system control function and a system Operation And Maintenance (OAM) function.

The switching waveform generator 401 includes a sawtooth wave generator (not illustrated) that generates a sawtooth wave with a predetermined frequency and amplitude. From the power converter control variable 308 and the orthogonal perturbation signal 309, the switching waveform generator 401 generates a reference value to be compared with the sawtooth wave. According to the result of the real-time comparison of the reference value and the sawtooth wave, the switching waveform generator 401 generates a switch control signal for controlling the switches 402 and 403.

For example, if the reference value is greater than the level of the sawtooth wave, the switching waveform generator 401 turns on the switch 402 and turns off the switch 403. If the reference value is smaller than the level of the sawtooth wave, the switching waveform generator 401 turns off the switch 402 and turns on the switch 403. That is, if the value of the power converter control variable 308 is great, the switching waveform generator 401 controls the switches 402 and 403 by generating a switch control signal providing a high duty ratio. For example, the power converter 102d of FIG. 8 is controlled by a duty ratio, and may be a cuk converter including the communicator (300) function capable of communicating a control variable. Unlike the power converter 102c of FIG. 7, the power converter 102d of FIG. 8 does not need a voltage or current sensor. Thus, the power converter 102d of FIG. 8 can be implemented at a relatively low cost.

The embodiments of the power converter has been described with reference to FIGS. 5 to 8. The power converters may be configured using a DC-DC converter according to a circuit mode of at least one of a buck converter, a cuk converter, a boost converter, a buck-boost converter, and a sepic converter.

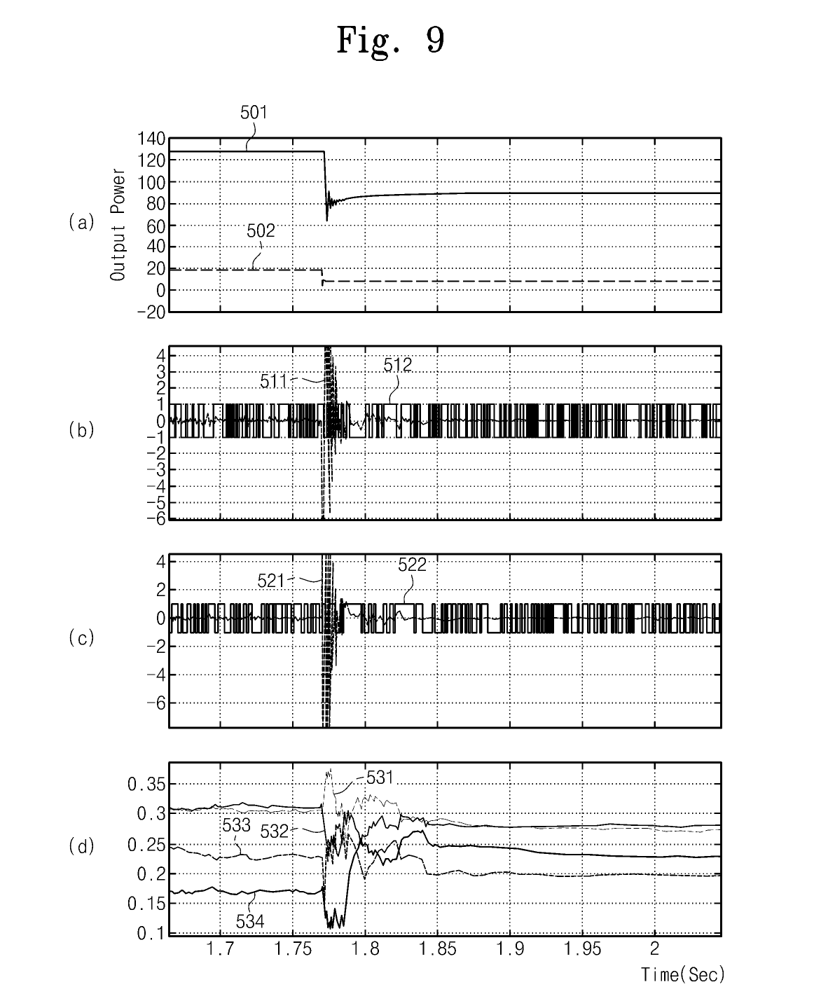

FIG. 9 illustrates the simulation results of the optimal output control system (illustrated in FIG. 4) using the voltage control type buck converter of FIG. 5 as a power converter. Circuit constants used in the simulation are a 1.35 mH inductor (see 202 of FIG. 4), a 100 μF load capacitor (see 203 of FIG. 4), a 0.02 Ohm load resistor (see 204 of FIG. 4), a 300 μF charge capacitor 301 for a power converter (see 102a of FIG. 5). Also, a low frequency filter (see 307 of FIG. 5) includes a 1 μF solar cell parasitic capacitor and a 10 μH inductor. Four PRBS signals with different initial values were used as an orthogonal perturbation source, and the integration term of cross-correlation was saturated at −1 and +1. The gain of a cross-correlator was 25, and a discrete integrator operating at 10 MHz was used. Four energy sources were connected in series through the power converter. For the respective energy sources, solar induced currents changed into sawtooth waveforms or step waveforms of [5 5 10 10], [10 10 5 5], [22 22 35 35], [20 20 30 30] ampere at the period of a time vector [0 1.0 1.11 1.777] second. Three cells were connected to each solar cell, and a saturation current of a unit cell was set to 7e⁻¹² ampere. FIG. 9 illustrates the operation condition between 1.675 second and 2.05 second.

In a waveform diagram (a), a waveform 501 represents the total power outputted to the load resistor. According to the waveform 501, the total power outputted to the load resistor (see 204 of FIG. 4) reveals a significant difference at 1.77 second. That is, the total power is the maximum power of 127.45 watt before 1.77 second, and it is reduced to 89.225 watt at 1.77 second. About 70 msec is taken to control it to 99% of the final maximum power. Also, the total power is controlled to a 92% power value within about 11 msec. Thus, the present invention has better performance than the known performance. The result disclosed in Reference Document 9 has an about 90% stabilization time of 20 msec (Reference Document 9: Jonathan W. Kimball and Philip T Krein, “Discrete-Time Ripple Correction Control for Maximum Power Point Tracking,” IEEE, Tran. on Power Electronics, Vol-23, No-5, page 2353-2362, Sept. 2008).

A waveform diagram (b) and a waveform diagram (c) illustrate orthogonal perturbation signals 512 and 522 and integration term waveforms 511 and 521 of a cross-correlator 112. It shows that the transient phenomenon of the integration term occurs when the output of the solar cell changes into a step form.

A waveform diagram (d) illustrate four power controller control variable signals 531, 532, 533 and 534. The waveforms 533, 532, 533 and 534 represent the first, second, third and fourth power converter control variable signals, respectively. According to the changes of a step generated at 1.77 second, the control variables are completely stabilized before 1.9 second point. Also, the control variables controlling the solar cells with low power converge to the final state at a relatively low speed. This means that a cross-correlator of a low-power solar cell having a relatively low orthogonal power using a quasi-orthogonal signal is more affected by a residual value of a cross-correlation operation.

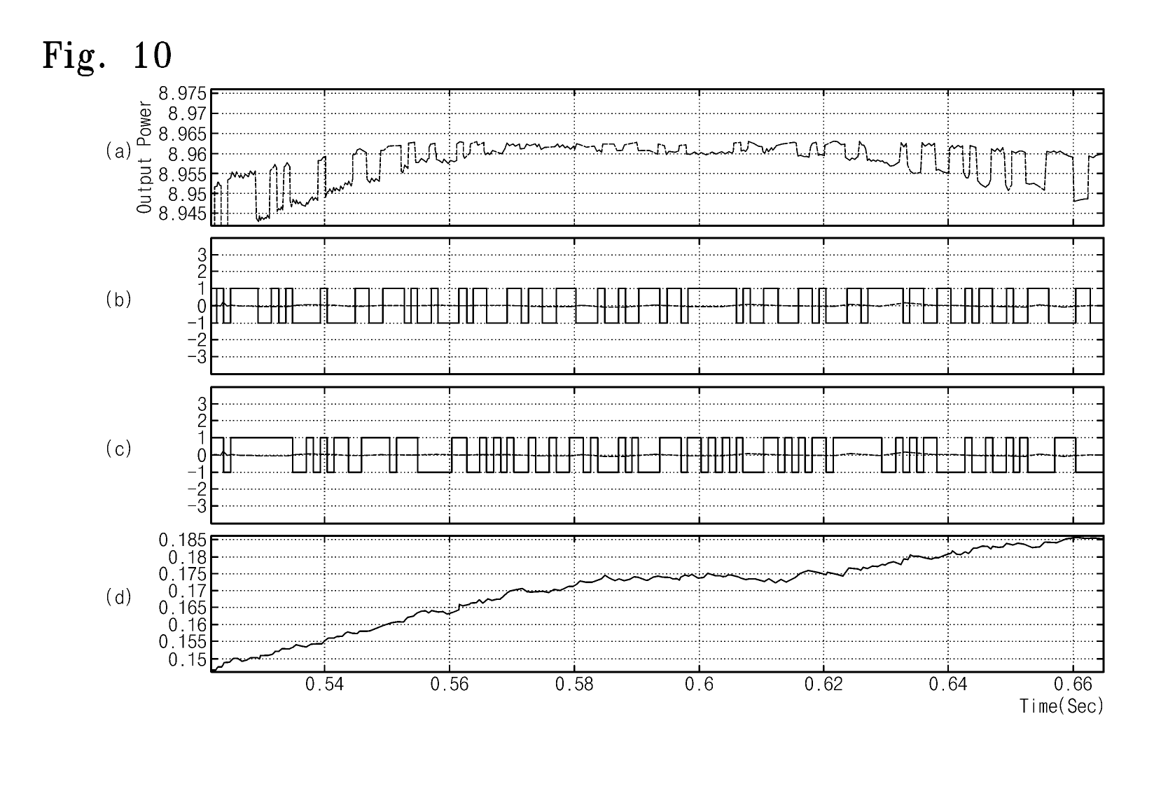

FIG. 10 is waveform diagrams illustrating an operation of the first solar cell adjacent to the maximum power output point.

A waveform in a waveform diagram (a) represents the output power of the first solar cell. The output waveform operates at the maximum power point between 0.58 sec and 0.62 sec. It can be seen that a phase inversion of a perturbation power waveform occurs before/after the maximum power point. That is, from a waveform diagram (b) illustrating a perturbation waveform, it can be seen that there is a phase inversion of a waveform corresponding to a perturbation power component in the output power illustrated in the waveform diagram (a).

It can be seen from the waveform diagram (a) that a stable operation point of the first solar cell is formed at a point 0.03 watt smaller than the maximum output point (8.962 watt). This is caused by a distortion of cross-correlation due to a quasi-orthogonal signal and a perturbation collection channel.

The above simulation results show that the present invention can connect multiple energy sources of various characteristics in series without an energy loss. Also, they show that the present invention can track their maximum power points rapidly and accurately.

As described above, the present invention uses a single power sensor to simultaneously and optimally control a plurality of power generation devices, thus making it possible to perform an energy-lossless optimal operation of a large-scale new renewable energy generation system including a combination of a plurality of power generation devices.

Also, the present invention connects a plurality of power generation devices, such as solar cell modules generating a low output voltage, in series without an energy loss, thus making it possible to provide efficient power generation.

Also, the present invention prevents a system power loss due to the solar cell output non-uniformity caused by clouds, thus making it possible to increase the power generation efficiency by about 37% to about 82% in comparison with typical solar power generation systems.

Also, the present invention implements a new renewable energy generation system with a distributed structure easy for fault tolerance, modularization and standardization, thus making it possible to provide an energy generation system with a long operation time and reduce the maintenance costs.

Also, the present invention uses different solar cells in a mixed manner, thus making it possible to provide a graceful BIPV (Building Integrated Photovoltaic) power generation system adapted to the functions of buildings. Also, the present invention makes it possible to use solar cells as the surface wall material of buildings, thus making it possible to reduce the construction costs of a BIPV system.

The above-disclosed subject matter is to be considered illustrative and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A maximum power tracking device comprising:
a capacitor configured to charge or discharge the output power received from a power generator; and
a switching control unit configured to control the charge or discharge of the capacitor according to a control variable and a perturbation reference signal corresponding to the power generator,
wherein the control variable is generated by cross-correlating orthogonal signal power included in the power generator with the perturbation reference signal.

2. The maximum power tracking device of claim 1, wherein the switching control unit comprises a hysteresis comparator configured to control the charge or discharge of the capacitor such that the amplitude of a current or a voltage output from the power generator is limited within an allowable range centered on a reference level determined by the control variable and the perturbation reference signal.

3. The maximum power tracking device of claim 2, further comprising:
a current or voltage measurer configured to measure the amplitude of the current or voltage output from the power generator and provide the measured amplitude to the hysteresis comparator.

4. The maximum power tracking device of claim 1, further comprising:
an inductor connected in series to the capacitor and configured to exchange energy with the capacitor according to the control of the switching control unit.

5. The maximum power tracking device of claim 1, further comprising:
a switch configured to charge or discharge the capacitor according to the control of the switching control unit.

6. The maximum power tracking device of claim 5, further comprising:
a low frequency filter configured to prevent a switching noise generated by the switching operation of the switch from entering the power generator.

7. The maximum power tracking device of claim 1, wherein the switching control unit comprises a switching waveform generator configured to control the charge or discharge of the capacitor with reference to the reference level determined by the control variable and the perturbation reference signal.

8. The maximum power tracking device of claim 1, further comprising:
an inductor configured to exchange energy with the capacitor according to the control of the switching control unit.

9. The maximum power tracking device of claim 7, further comprising:
switches configured to control the charge or discharge of the capacitor according to the control of the switching control unit.

10. The maximum power tracking device of claim 1, further comprising:
a low frequency filter configured to prevent a switching noise generated by the switching operations of the switches from entering the power generator.

11. The maximum power tracking device of claim 1, further comprising:
a communicator configured to receive the control variable from an external entity.

12. The maximum power tracking device of claim 1, wherein the capacitor and the switching control unit constitute a power converter that is a DC-DC converter driven according to a circuit mode of at least one of a buck converter, a cuk converter, a boost converter, a buck-boost converter, and a sepic converter.

13. A maximum power tracking control method, comprising:
adding a first perturbation reference signal to the output of a first power generator and adding a second perturbation reference signal to the output of a second power generator, the second perturbation reference signal being orthogonal to the first perturbation signal;
extracting a perturbation power from the sum of the output of the first power generator and the output of the second power generator;
cross-correlating the extracted perturbation power with the first and second perturbation reference signals; and
controlling the output powers of the first power generator and the second power generator with reference to a control variable generated according to a result of the cross-correlating.

14. The maximum power tracking control method of claim 13, further comprising:
performing a filtering operation to separate the perturbation power from the output of the first power generator or the second power generator.

15. The maximum power tracking control method of claim 13, wherein cross-correlating the extracted perturbation power with the first and second perturbation reference signals comprises measuring propagation delay time of the first and second perturbation reference signals for performing a cross-correlation operation.
